(19) United States
(12) Patent Application Publication
(10) Pub. No.: US 2004/0170265 A1
(43) Pub. Date: Sep. 2, 2004

(54) Conference call security

(76) Inventors: David S. Benco, Winfield, IL (US); Daisy Diaz, Miami, FL (US); Karla Rae Hunter, Naperville, IL (US); Ronald Bruce Martin, Carol Stream, IL (US)

Correspondence Address: PATTI & BRILL, ONE NORTH LASALLE STREET, 44TH FLOOR, CHICAGO, IL, 60602, US

(21) Appl. No.: 10/376,968

(22) Filed: Feb. 27, 2003

(51) Int. Cl. H04M 3/42

(52) U.S. Cl. 379/202.01

(57) ABSTRACT

Conference call security is enhanced by a process for validating participants seeking to join the conference call by terminating an incoming call at a conference bridge and requiring a valid conference code input by the caller. A type of security to be utilized for the particular conference call is determined. A first validation method determines if the caller is authorized to access the conference call, and if the caller is validated, granting the caller access to participate in the conference call. If the first validation method does not validate the caller, a second validation method that is different from the first validation method is used to determine if the caller is authorized to access the conference call. If the second validation method validates the caller, the caller is granted access to participate in the conference call. If the second validation method does not validate the caller, the caller is denied access to participate in the conference call.

### BACKGROUND

This invention is generally directed to the conferencing of telephone calls in a telecommunications system, and is more specifically directed to providing security to validate that callers seeking access to a predetermined conference call are authorized to participate in the conference call.

Conference calls are supported in a variety of ways. A 3-way conferencing function can be performed by most modern telecommunication switches, e.g. the 5ESS® switch by Lucent Technologies Inc. Such 3-way conferencing typically provides no call security since only three parties are involved and one of the parties will have direct control over adding the third party. Conference call bridges that can support many participants are available from several manufacturers. These bridges are connected to a telecommunications switch and serve as an adjunct capable of terminating a plurality of incoming telephone calls. After dialing a predetermined telephone number to reach the conference bridge, participants typically enter a conference code associated with a specific conference. The party arranging the conference call may seek to allow only authorized participants by having an operator associated with the conference call service intercept each party attempting to join the conference call and obtain information from each caller to validate that the caller is authorized to participate in the conference call. The information obtained by each caller may consist of the caller's name that is checked by the operator against a predetermined list of authorized participants. Alternatively, each authorized conference call participant may have been previously issued an access code number that must be entered after an automated voice prompt by the conference bridge in order to be authenticated as an authorized participant and gain access to the conference call. The same access code number is normally used by all participants of a particular conference call.

Although the above techniques for validating the authority of callers seeking to enter a conference call have generally been successful, there exists a need for improved security especially for situations in which highly sensitive or proprietary information will be discussed during the conference call.

### SUMMARY OF THE INVENTION

It is an object of the present invention to provide improved security for conference calls without requiring manual intervention by an operator.

In accord with an embodiment of the present invention, conference call security is enhanced by a process for validating participants seeking to join the conference call by terminating an incoming call at a conference bridge and requiring a valid conference code input by the caller. A type of security to be utilized for the particular conference call is determined. A first validation method determines if the caller is authorized to access the conference call, and if the caller is validated, granting the caller access to participate in the conference call. If the first validation method does not validate the caller, a second validation method that is different from the first validation method is used to determine if the caller is authorized to access the conference call. If the second validation method validates the caller, the caller is granted access to participate in the conference call. If the second validation method does not validate the caller, the caller is denied access to participate in the conference call.

An improved conference bridge for practicing the conference call security is a further embodiment of the present invention.

### BRIEF DESCRIPTION OF THE DRAWINGS

FIG. 1 is a block diagram of a telecommunications system incorporating a conference bridge in accordance with the present invention.

FIG. 2 is a block diagram of an exemplary conference bridge in accordance with the present invention.

FIG. 3 is a flow diagram illustrating an exemplary method for providing improved conference call security in accordance with the present invention.

### DETAILED DESCRIPTION OF PREFERRED EMBODIMENTS

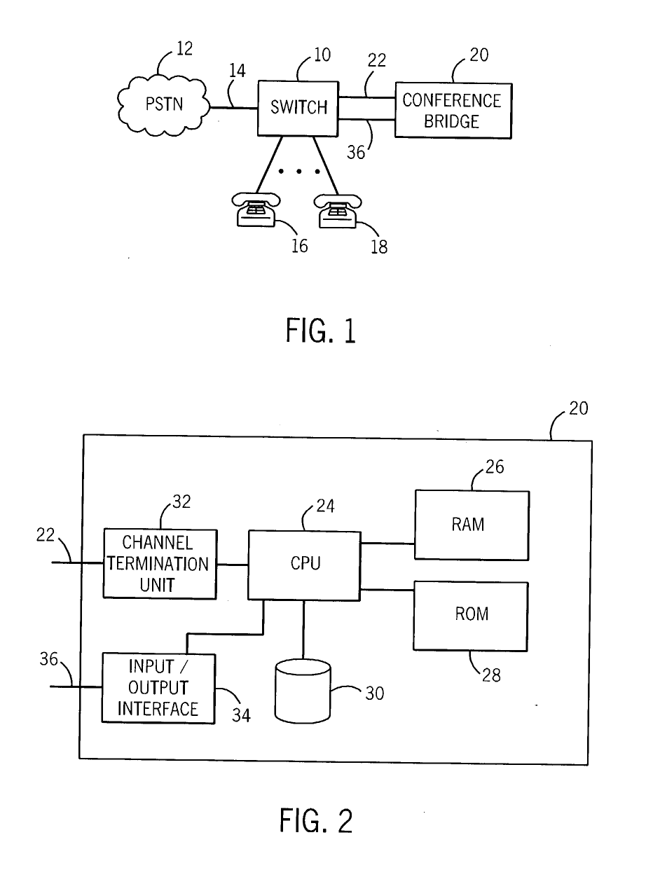

FIG. 1 illustrates a telecommunications system including a telecommunications switch 10, e.g. a class five switch, that is connected to the public switched telephone network (PSTN) 12 by one or more communication channels 14. Exemplary telephone sets 16 and 18 are connected to the switch 10 by corresponding telephone lines. A conference bridge 20 is connected to switch 10 by communication channel 22. Depending upon the number of participants that can be simultaneously terminated by the conference bridge 20, channel 22 may consist of a plurality of telephone lines that each carry only one call or may consist of one or more trunk lines each capable of carrying a plurality of simultaneous telephone calls. As will be apparent to those skilled in the art, any telephone set connected to switch 10 or that can be coupled through the PSTN 12 to switch 10 is capable of being a participant in a conference call supported by conference bridge 20. For purposes of clarity FIG. 1 illustrates voice path channels, and does not illustrate the use of a known command and control signaling network, e.g. an SS7 network, except to show channel 36 that carries command and control signals between switch 10 and the conference bridge 20.

FIG. 2 is a block diagram of an exemplary conference bridge 20 in accordance with the present invention. A central processing unit, e.g. a microprocessor, 24 is coupled to and supported by random access memory (RAM) 26, read-only memory (ROM) 28, and a nonvolatile storage device 30 such as a disk drive. A channel termination unit 32 operates under the control of CPU 24 and terminates incoming calls over channel 22. In addition to being able to terminate incoming calls, channel termination unit 32 can conference or combine incoming calls to form one or more conference calls based on directions provided by CPU 24. An input/output interface 34 is coupled to CPU 24 and enables the conference bridge 20 to receive and transmit command and control signals by channel 36 with switch 10 and the telecommunication signaling network (not shown). The CPU 24 operates under stored program control instructions and enables the conference bridge 20 to provide call conferencing functions including enhanced security capabilities described below.

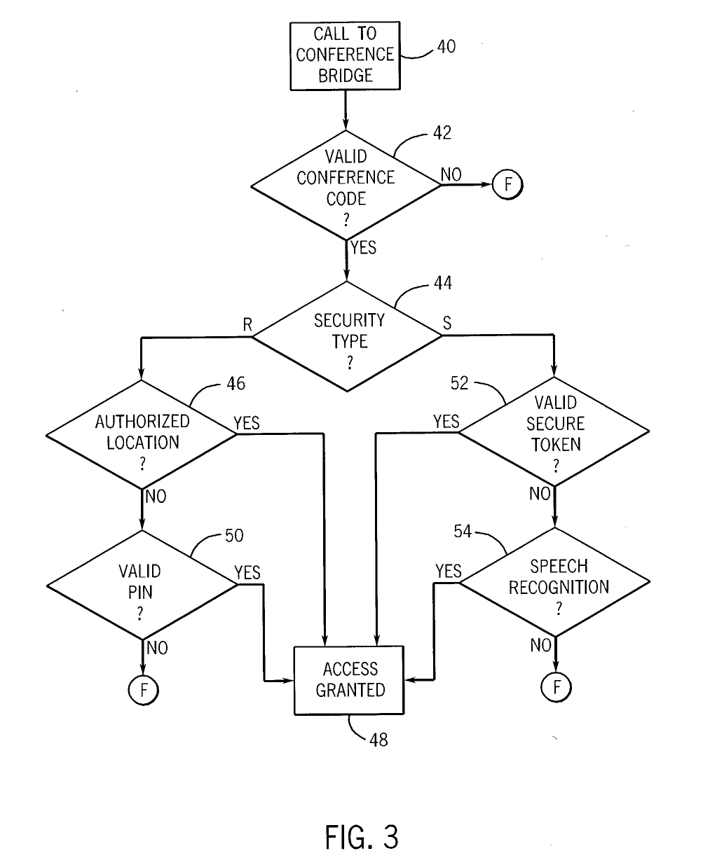

FIG. 3 is a flow diagram of an exemplary method for providing improved security for validating conference call participants. Prior to the scheduled time for the beginning of the conference call, a host or administrator desiring to set up a conference call will have made arrangements to schedule a particular conference call. The arrangements will typically include the host specifying the number of participants or at least a maximum number of permitted participants, and a duration or maximum duration of the conference call. These arrangements can be communicated by a voice call from the host to a conference bridge operator who will enter the appropriate information in the conference bridge. Alternatively, the arrangements can be directly input into the conference bridge by the host such as by an Internet supported web site operated by the conference bridge service provider. Depending upon the security measures desired by the host, instructions may be input by the host for use by the conference bridge in implementing the desired security measures.

Beginning in step 40, an incoming call is received from a caller seeking to participate in a conference call and is terminated by the conference bridge from switch 10. A determination is made by step 42 of whether the caller has input a valid conference code. The host upon scheduling the conference call will have been assigned a conference code, e.g. a several digit number, by the conference bridge service provider. It is normally the duty of the host to properly distribute the assigned conference code to the desired participants. As is known in the art, an audible prompt can be played to the caller requesting the caller to input the conference code by DTMF tones. A NO determination by step 42 results in a failure (F) that terminates the attempt by the caller to gain access to the conference call. As will be known to those skilled in the art, a decision step may permit the caller one or more additional opportunities to enter a correct response before reaching a final failure determination.

A YES determination by step 42, indicating that a valid conference code has been entered, is followed by a security type determination in step 44. In the exemplary method two types of security are shown, R and S. In one embodiment the security type to be utilized for all participants of a particular conference call is selected by the host during the set up of the conference call. In another embodiment, the host elects to have the security type dynamically selected based on a parameter associated with the caller currently being validated. For example, one type of security may be selected if the caller is calling from a telephone set having a office code (known from the calling party identification information/number CLID) that is within a group of predetermined office codes selected by the host, and another type of security selected if the office code is not within the group of predetermined office codes. A less robust type of security could be selected where the office code of the caller is only utilized by one company and most of the participants in the subject conference call will be employees of the Company calling from the office code(s) assigned to company facilities.

For purposes of illustration, assume that the host has elected during the set up of the conference call to use security type R to validate all participants. Thus, the caller will be routed to determination step 46 that will determine whether the call originates from an authorized location. This determination can be based on the caller's CLID, and more specifically whether the caller's office code is on a list of office codes provided by the host during the set up of the conference call. In the exemplary conference call, the host anticipates that almost all of the authorized participants will be employees of one company and that they will be calling from telephone sets at company offices associated with only three office codes. A YES determination by step 46, indicating that the caller is calling from an office code that is on the predetermined list, results of the caller being granted access to the conference call at step 48. A NO determination by step 46 gives the caller a further opportunity to be validated by determination step 50. In this step, the caller is prompted to input a PIN, which may either be a truly “personal” identification number or may be a number determined by the host to be used by all participants of a particular conference call. This secondary form of validation that utilizes a different form of validation from the preceding step adds significant flexibility to the security system. For example, it permits an employee of the Company who would normally be at an authorized office code location, but is at a non-company location at the time of the conference call, to be able to participate in the conference call by entering a valid PIN. A NO determination by step 50 results in a failed security determination and denial of access to the conference call for the caller. A YES determination by step 50 causes the caller to be granted access and added to the conference call at step 48.

The sequencing of the security measures associated with steps 46 and 50 provides an advantage. Where it is anticipated that a substantial number of the participants will be calling from an authorized location (step 46), the automated validation associated with using the CLID to obtain the caller's office code makes the process convenient for such callers and minimizes the time required to complete the validation process. If steps 46 and 50 were reversed in order, all callers (not just some of the callers) would be required to enter a PIN.

With the order of steps 46 and 50 shown in FIG. 3, a desired level of security is obtained while simultaneously minimizing obligations placed on many of the callers.

Returning to determination step 44, assume that the host on setting up the conference call elected to have security type S utilized for all participants. Following a valid conference code determination by step 42, step 44 will route the caller for further security measures to determination step 52. An audible prompt may be played to the caller requesting the caller to input a secure token. In this example, a secure token consists of a series of pseudorandom numbers generated by an independent device carried by the caller. The pseudorandom number sequence changes periodically. The pseudorandom number sequences and their periodicity are either calculated by or made available to the conference bridge. Thus, the secure token entered by the caller can be compared against the anticipated secure token during that time interval. A YES determination by step 52, indicating that the secure token entered by the caller matches the anticipated secure token, results of the caller being granted access and entering the conference call as indicated that step 48.

A NO determination by step 52 results in the caller being given a further opportunity to establish validation using a different form of security. In determination step 54 automatic speech recognition is utilized as a method to validate the caller. Preferably an audible prompt is played to the caller requesting the caller to speak a word sequence. If a list of the names of authorized callers was entered by the host, the caller can be requested to speak his name. If the text-based name determined by the automatic speech recognition corresponds to a name on the list, the caller is validated. Alternatively, participants of the conference call may be required by the host to call a designated number associated with the conference bridge prior to the time of the conference call and input the caller's spoken name that will be stored for later use in validating callers in step 54. In still a further example, the host may specify a predetermined word sequence, such as “black cat”, that would be entered during the setup of the conference call and made known to the participants to constitute a valid spoken password as determined by step 54. A NO determination by step 54 results in validation failure and denial of access to the conference call. A YES determination by step 54 results in the caller being granted access and coupled to the conference call.

Although embodiments of the invention have been described above and shown in the drawings, the scope of the invention is defined by the claims that follow. The description of the embodiments and methods are exemplary and are not to be considered as limiting.

We claim:

1. A method for validating participants to a conference call comprising the steps of:
terminating an incoming call at a conference bridge;
receiving a valid conference code input by the caller;
determining a type of security to be utilized for the conference call associated with the conference code;
utilizing a first validation method to determine if the caller is authorized to access the conference call;
if the first validation method validates the caller, granting the caller access to participate in the conference call;
if the first validation method does not validate the caller, utilizing a second validation method that is different from the first validation method to determine if the caller is authorized to access the conference call;
if the second validation method validates the caller, granting the caller access to participate in the conference call;
if the second validation method does not validate the caller, denying the caller access to participate in the conference call.

2. The method according to claim 1 further comprising the step of obtaining from a host associated with setting up the conference call a type of security instruction, and storing said instruction, the step of determining a type of security to be utilized for the conference call associated with the conference code being based on said instruction.

3. The method according to claim 2 wherein said instruction causes the determining of the type of security step to make a dynamic determination of the type of security to be utilized based on a parameter associated with the caller.

4. The method according to claim 1 wherein the first validation method requires substantially less input manually entered by the caller than the second validation method.

5. The method according to claim 1 wherein the first validation method utilizes information available from the calling line identification information associated with the caller.

6. The method according to claim 1 wherein one of the first and second validation methods utilizes a personal identification number input by the caller for validation.

7. The method according to claim 1 wherein one of the first and second validation methods utilizes a secure token consisting of a periodically changing pseudorandom number input by the caller.

8. The method according to claim 1 wherein one of the first and second validation methods utilizes automated speech recognition to validate input spoken by the caller.

9. A conference bridge for validating participants to a conference call comprising:
means for terminating an incoming call;
means for receiving a valid conference code input by the caller;
means for determining a type of security to be utilized for the conference call associated with the conference code;
first means for validating if the caller is authorized to access the conference call;
second means for validating if the caller is authorized to access the conference call, the validation by the second means being different from the validation by the first means, the validation by the second means being employed only if the validation by the first means does not validate the caller;
means for granting the caller access to participate in the conference call if one of the first and second means validates the caller;
means for denying the caller access to participate in the conference call if the second means does not validate the caller.

10. The conference bridge according to claim 9 further comprising means for receiving from a host associated with setting up the conference call an instruction defining a type of security to be used, and means for storing said instruction, the determination by the means for determining a type of security being based on said instruction.

11. The conference bridge according to claim 10 wherein said instruction causes the means for determining of the type of security step to make a dynamic determination of the type of security to be utilized based on a parameter associated with each caller.

12. The conference bridge according to claim 9 wherein the first means for validating requires substantially less input manually entered by the caller than the second means for validating.

13. The conference bridge according to claim 12 wherein the first means utilizes information available from the calling line identification information associated with the caller.

14. The conference bridge according to claim 12 wherein the second means utilizes a personal identification number input by the caller for validation.

15. The conference bridge according to claim 9 wherein one of the first and second means utilizes a secure token consisting of a periodically changing pseudorandom number input by the caller.

16. The conference bridge according to claim 9 wherein one of the first and second means utilizes automated speech recognition to validate input spoken by the caller.
